(19) United States
(12) Patent Application Publication
(10) Pub. No.: US 2021/0175009 A1
(43) Pub. Date: Jun. 10, 2021

(54) Wireless Power Transmission with Current-Limiting Coil

(71) Applicant: Silanna Asia Pte Ltd, Singapore (SG)

(72) Inventors: Pasi Tapani Tikka, Tallinn (EE); Kalle Arulaane, Tallinn (EE); Martin Kortsparn, Tallinn (EE)

(73) Assignee: Silanna Asia Pte Ltd, Singapore (SG)

(21) Appl. No.: 17/249,111

(22) Filed: Feb. 19, 2021

Related U.S. Application Data
(62) Division of application No. 16/413,960, filed on May 16, 2019.

(51) Int. Cl. H01F 27/34; H02J 50/12; H01F 38/14

(52) U.S. Cl. CPC H01F 27/34; H01F 38/14; H02J 50/12

(57) ABSTRACT

A wireless power transmission system includes a transmitter coil in a power transmitting circuit and a receiver coil in a power receiving circuit. Either the receiver coil serves as a current-limiting coil or the system also includes a current-limiting coil that is separate from the transmitter coil and the receiver coil. The transmitter coil generates a magnetic field from a transmitter current flowing therethrough. The current-limiting coil generates an opposing magnetic field from the magnetic field, which limits the transmitter current, in a current-limiting mode.

### RELATED APPLICATIONS

This application is a divisional of U.S. patent application Ser. No. 16/413,960, filed on May 16, 2019, and entitled, “Wireless Power Transmission with Current-Limiting Coil”, all of which is hereby incorporated by reference in its entirety and for all purposes.

### BACKGROUND

A wireless power transmission system typically enables power transfer across a gap between a transmitter device on a primary side to a receiver device on a secondary side. The transmitter device typically uses a primary or transmitter coil to generate a time-varying magnetic field from an electrical transmitter current that has an appropriate frequency. The receiver device (e.g., a smart phone, battery charger, etc.) has a secondary or receiver coil that can be placed within the magnetic field, thereby wirelessly coupling the transmitter coil to the receiver coil, such that the magnetic field induces an alternating current in the receiver coil. The alternating current is then commonly rectified and regulated to generate a DC output current for powering other electronic circuitry in the receiver device or for power storage in a battery.

The amount of power transmitted from the transmitter coil to the receiver coil and the load that is induced within the transmitter coil partly depend on how strongly the receiver coil is electromagnetically coupled with the transmitter coil. The strength of the electromagnetic coupling depends on the placement of the receiver coil with respect to the magnetic field generated by the transmitter coil. When placed at an optimum location and orientation within the magnetic field, i.e., where the magnetic flux is greatest and the receiver coil is properly aligned with it (e.g., where the two coils are close together and aligned on the same axis), the coupling between the receiver coil and the transmitter coil is optimal. In this case, the power transfer between the two coils and the load induced within or exhibited by the transmitter coil are at a maximum. At greater distances or misalignment, the coupling is decreased or weakened, and the transferred power and induced load are decreased.

The total series resistance seen by the transmitter circuit of the transmitter device (which determines the level of the transmitter current) includes the reflected resistance of the transmitter coil (variable due to the induced load), parasitic resistance of the transmitter coil (generally constant), a parasitic resistance of any additional wires (relatively negligible), and an inner resistance of a source of the power for the transmitter current (relatively constant). When the receiver coil is removed completely (or far away) from the magnetic field, the load exhibited by, or the reflected resistance of, the transmitter coil approaches a minimum or a no-load resistance level, i.e., without any induced load. The no-load resistance is on the order of about 1-2 Ohms, which is in effect a short circuit of the transmitter coil. In this case, if the source of the power is a DC voltage source, then the level of the transmitter current can increase considerably, due to the low overall resistance. The higher transmitter current can cause problems, such as overheating. Therefore, wireless power transmission systems typically have a means for detecting the no-load situation and reducing the current and/or voltage applied to the transmitter coil. However, when the receiver coil is not removed completely from the magnetic field, but perhaps moved away by only a few centimeters (e.g., so that there is a larger than optimal gap between the transmitter coil and the receiver coil), then the load exhibited by the transmitter coil can decrease even though the receiver coil is still within the magnetic field and generating current from the transferred power. The decrease of the induced load can be enough to cause the transmitter current to increase sufficiently to result in increased heating within the transmitter device, decreased efficiency in power transfer to the receiver device, increased current generated by the receiver coil, and/or increased heating within the receiver device.

Since it is easy for a person to fail to place the receiver device in the optimum location with respect to the transmitter device, there is a high likelihood that the gap between the receiver coil and the transmitter coil may be larger than the optimal distance for an extended period of time, thereby increasing the chance of overheating and damaging the transmitter device or the receiver device. It is necessary, therefore, to provide for limiting the transmitter current during operation of the transmitter device for proper power control and protection. Conventional techniques for limiting or reducing the transmitter current involve reducing the input voltage applied to the transmitter coil in response to current or voltage feedback data in the transmitter device or from the receiver device. The result, however, is a relatively low level of power transferred to the receiver device, thereby producing relatively low levels of current and voltage in the receiver device.

### SUMMARY

In accordance with some embodiments, an improved wireless power transmission system includes a transmitter coil, a receiver coil, and a current-limiting coil. The transmitter coil is in a power transmitting circuit. The transmitter coil generates a magnetic field for transmitting electromagnetic power by a transmitter current flowing within the transmitter coil. The receiver coil is in a power receiving circuit and can be disposed within the magnetic field for receiving at least a portion of the electromagnetic power and generating a receiver current therefrom. The current-limiting coil is disposed within the magnetic field. The current-limiting coil is configured to operate in a current-limiting mode and to operate in a non-current-limiting mode. The current-limiting coil generates an opposing magnetic field from the magnetic field in the current-limiting mode. The opposing magnetic field limits the transmitter current. The current-limiting coil does not generate the opposing magnetic field in the non-current-limiting mode.

In accordance with some embodiments, an improved wireless power transmission system includes a transmitter coil in a power transmitting circuit and a receiver coil in a power receiving circuit. The transmitter coil generates a magnetic field for transmitting electromagnetic power by a transmitter current flowing within the transmitter coil. The receiver coil can be disposed within the magnetic field. The receiver coil is configured to operate in a power receiving mode and to operate in a current-limiting mode. The receiver coil receives at least a portion of the electromagnetic power from the magnetic field. The receiver coil generates a receiver current and a first opposing magnetic field from the magnetic field in the power receiving mode. The receiver coil generates a second opposing magnetic field from the magnetic field without generating the receiver current in the current-limiting mode. The second opposing magnetic field has a greater magnitude that that of the first opposing magnetic field. The second opposing magnetic field limits the transmitter current.

In accordance with some embodiments, a method includes generating a transmitter current in a power transmitting circuit; applying the transmitter current to a transmitter coil in the power transmitting circuit; the transmitter coil generating a magnetic field for wirelessly transmitting electromagnetic power due to the transmitter current; during a non-current-limiting mode, the transmitter coil receiving a first opposing magnetic field that is generated from the magnetic field by a receiver coil that is disposed within the magnetic field; during a current-limiting mode, the transmitter coil receiving a second opposing magnetic field that is generated from the magnetic field by the receiver coil, the second opposing magnetic field having a greater magnitude than the first opposing magnetic field in the current-limiting mode; and during the current-limiting mode, limiting the transmitter current in the power transmitting circuit below a safe operating current threshold due to the second opposing magnetic field.

In accordance with some embodiments, a method includes generating a transmitter current in a power transmitting circuit; applying the transmitter current to a transmitter coil in the power transmitting circuit; the transmitter coil generating a magnetic field for wirelessly transmitting electromagnetic power due to the transmitter current; during a current-limiting mode, the transmitter coil receiving an opposing magnetic field that is generated from the magnetic field by a current-limiting coil that is disposed within the magnetic field; during the current-limiting mode, limiting the transmitter current in the power transmitting circuit due to the opposing magnetic field; and during a non-current-limiting mode, the transmitter coil not receiving the opposing magnetic field.

### BRIEF DESCRIPTION OF THE DRAWINGS

FIG. 1 is a simplified schematic of an example wireless power transmission system, in accordance with some embodiments.

FIG. 2 shows alternative simplified schematic diagrams of a portion of the example wireless power transmission system shown in FIG. 1, in accordance with some embodiments.

FIG. 3 is a table showing test results of a test implementation of the example wireless power transmission system shown in FIG. 1, in accordance with some embodiments.

FIG. 4 is a simplified schematic diagram of an example implementation of the example wireless power transmission system shown in FIG. 1, in accordance with some embodiments.

FIG. 5 is a simplified schematic diagram of another example implementation of the example wireless power transmission system shown in FIG. 1, in accordance with some embodiments.

FIG. 6 is a simplified schematic diagram of an example implementation of another example wireless power transmission system, in accordance with some embodiments.

FIG. 7 is simplified schematic diagrams of a portion of the example implementation of the example wireless power transmission system shown in FIG. 6, in accordance with some embodiments.

FIG. 8 is a simplified schematic diagram of an example prior art wireless power transmission system.

### DETAILED DESCRIPTION

Embodiments of an improved wireless power transmission system as described herein allow power transmission from a resonant transmitter coil in a transmitter device to a resonant receiver coil in a receiver device during a regular operation mode (or non-current-limiting mode), but limit the current in the transmitter coil during a current-limiting mode while maintaining the level of power transferred to the receiver coil and the levels of the current and voltage produced therein at or near the levels achieved during the regular operation mode. This level of operation can be achieved with only a minor drop in power transfer efficiency.

The wireless power transmission system includes one or more current-limiting coils disposed within a time-varying magnetic field generated by transmitter current flowing in the transmitter coil. The current-limiting coil is designed or configured such that, during the current-limiting mode, it generates an opposing magnetic field that induces an additional load in the transmitter coil, thereby causing the transmitter current to be limited to an acceptable maximum level. In some embodiments, the current-limiting coil is a separate coil from the resonant transmitter coil and the resonant receiver coil. In some embodiments, the receiver coil serves also as the current-limiting coil. In some embodiments, end nodes or terminals of the current-limiting coil may be wire connected together via a short circuit or a small resistance. Alternatively, the current-limiting coil may be a resonating structure, such as an LC circuit.

The current-limiting coil can be part of, or wire connected to, a power transmitting circuit in the transmitter device or to a power receiving circuit in the receiver device. Additionally, the current-limiting coil can be disposed within the transmitter device, disposed within the receiver device, or disposed outside both the transmitter device and the receiver device. If disposed outside both the transmitter device and the receiver device, the current-limiting coil is electrically wire connected to the power transmitting circuit or the power receiving circuit. In some embodiments, multiple current-limiting coils can be used in a combination of these configurations.

As used herein, a “wire connection” is contrasted with a “wireless connection,” which is an electromagnetically induced coupling, such as an inductive coupling between the transmitter coil, the receiver coil, and the current-limiting coil. Thus, terms related to a “wire connection” between any two components refer to an electrical connection through a wire and/or one or more other electronic components, but without any intervening wireless connection.

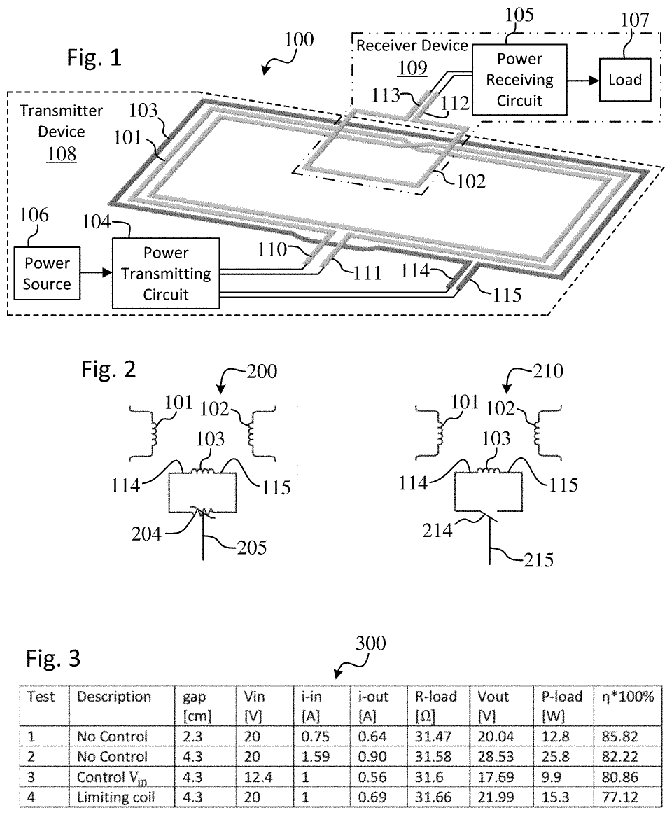

FIG. 1 shows an example improved wireless power transmission system 100, in accordance with some embodiments. The wireless power transmission system 100 is an example of an embodiment in which the current-limiting coil is a separate coil from the transmitter coil and the receiver coil. In this embodiment, the current-limiting coil is being part of, or wire connected to, a power transmitting circuit, and the current-limiting coil is disposed within a transmitter device.

The wireless power transmission system 100 generally includes a transmitter coil 101, a receiver coil 102, a current-limiting coil 103, a power transmitting circuit 104, a power receiving circuit 105, a power source 106, and a load 107, among other components not shown for simplicity. In this embodiment, the transmitter coil 101, the current-limiting coil 103, the power transmitting circuit 104, and (optionally) the power source 106 are part of a transmitter device 108; and the receiver coil 102, the power receiving circuit 105, and (optionally) the load 107 are part of a receiver device 109. Thus, the transmitter coil 101 and the current-limiting coil 103 are wire connected to (and may be considered part of) the power transmitting circuit 104; and the receiver coil 102 is wire connected to (and may be considered part of) the power receiving circuit 105.

The transmitter coil 101 may be any appropriate coil of conductive material that can generate a time-varying magnetic field under the power of a transmitter current (e.g., applied at end nodes 110 and 111), wherein the time-varying magnetic field is sufficient to couple with and transfer electromagnetic power to the receiver coil 102. The receiver coil 102 may be any appropriate coil of conductive material that can generate an alternating current (e.g., at end nodes 112 and 113) induced therein by the time-varying magnetic field, wherein the alternating current is sufficient (e.g., when rectified and/or regulated) to power the load 107. The current-limiting coil 103 may be any appropriate coil of conductive material that is coupled with the transmitter coil 101 and has relatively low active resistance, but a variable reactive resistance. The electromagnetic coupling does not have to be very strong, but can be a relatively loose coupling, e.g., around one to ten percent coupling or slightly higher.

The transmitter coil 101, the receiver coil 102, and the current-limiting coil 103 are shown in perspective to illustrate that, in this example, the transmitter coil 101 and the current-limiting coil 103 are in the same plane (except where wires of the coils 101 and 103 cross), and the receiver coil 102 is in a parallel, but offset (e.g., higher), plane. Thus, the transmitter coil 101 and the current-limiting coil 103 may be disposed together within the same transmitter device housing (not shown), or within the same layers of a multi-layer board or pad (not shown), on or near which the receiver coil 102 may be placed.

Additionally, the current-limiting coil 103 is shown as being disposed outside of and offset from an outer periphery of the transmitter coil 101 (defined by an outermost loop of the transmitter coil 101). In other embodiments, the current-limiting coil 103 may be disposed inside of and offset from an inner periphery of the transmitter coil 101 (defined by an innermost loop of the transmitter coil 101). In still other embodiments, the current-limiting coil 103 may be disposed in a different plane above or below the transmitter coil 101, such that the current-limiting coil 103 may be, not only outside the outer periphery or inside the inner periphery of the transmitter coil 101, but alternatively between the two peripheries, albeit vertically or axially offset from the transmitter coil 101. For example, the current-limiting coil 103 may be within a different layer of a multi-layer board or pad than that of the transmitter coil 101, or the current-limiting coil 103 may be outside of a transmitter device housing, whereas the transmitter coil 101 is inside.

The illustrated embodiment of FIG. 1 includes only one current-limiting coil 103. However, other embodiments may include more than one current-limiting coil in any combination of locations or configurations with respect to the inner and outer peripheries and the plane of the transmitter coil 101, as mentioned previously.

The power source 106 generally represents any appropriate AC or DC source of electrical power. The power source 106 may also represent any appropriate power converter or regulator (unless such circuitry is included in the power transmitting circuit 104) for converting the power to an appropriate DC power for operation of the power transmitting circuit 104.

The power transmitting circuit 104 generally represents any appropriate circuitry for generating an alternating transmitter current from the input power received from the power source 106 and applying the transmitter current to the transmitter coil 101 (e.g., at the end nodes 110 and 111) to generate the time-varying magnetic field in the vicinity of the transmitter coil 101. The transmitter current is generated with an appropriate frequency so that the magnetic field varies at a desired frequency for the given application of the wireless power transmission system 100. The power transmitting circuit 104 also generally represents any appropriate circuitry for operating (e.g., turning on and off) the current-limiting coil 103 (e.g., at end nodes 114 and 115) to limit the current level of the transmitter current (when needed) to prevent overheating of, or damage to, the transmitter device 108 and/or the receiver device 109.

The power receiving circuit 105 generally represents any appropriate circuitry for generating a desired output current from the alternating current induced in the receiver coil 102 due to the time-varying magnetic field. The output current, e.g., a DC current, is applied to the load 107.

The load 107 generally represents any appropriate circuitry that can use the electrical power that has been transferred to the receiver device 109. For example, if the receiver device 109 is a cellphone, the load 107 may represent a battery (and supporting circuitry) to be charged by the transferred power or any of the electronic components that can be powered by the transferred power to perform the functions of a cellphone.

Not to be limited by theory, if the coupling between the current-limiting coil 103 and the power receiving circuit 105 is small compared to the couplings between the power transmitting circuit 104 and the current-limiting coil 103 and between the power transmitting circuit 104 and the power receiving circuit 105, which is generally the case for the wireless power transmission system 100, it can be shown that the transmitter current (I_{PTG}) is:

$${I}_{P T C} = \frac{{V}_{i n}}{\frac{{ω}^{2} {M}_{PTC - lim}^{2}}{{R}_{lim} + {x}_{lim}} + \frac{{ω}^{2} {M}_{P T C - P R C}^{2}}{{R}_{P R C}} + {R}_{P T C}} .$$

Where the subscript “PTC” refers to the power transmitting circuit 104, the subscript “PRC” refers to the power receiving circuit 105, the subscript “lim” refers to the current-limiting coil 103, ω=2πf is an angular frequency of the system, M is mutual inductance, R is active or parasitic resistance, and X is reactance. Therefore, for example, the term M_{PTC-lim} is the mutual inductance between the power transmitting circuit 104 and the current-limiting coil 103. Thus, the left and middle terms in the denominator can generally be treated as resistances, even though they are not. The left term is the reflected load in the power transmitting circuit 104 created by the current-limiting coil 103, and the middle term is the reflected load in the power transmitting circuit 104 created by the receiver coil 102.

The wireless power transmission system 100 controls the transmitter current by changing the value of the left term in the denominator. This control is generally done by changing the reactance Xₗᵢₘ of the current-limiting coil 103. For example, when the current-limiting coil 103 is tuned to resonate at the system frequency, the reactance will be zero. What remains in the left term is generally just the parasitic resistance of the current-limiting coil 103, so the left term becomes:

$$\frac{{ω}^{2} {M}_{PTU - lim}^{2}}{{R}_{lim}} .$$

For example, the value of this term can be approximately 10 kΩ. As a result, the current-limiting coil 103 can significantly reduce the transmitter current, almost to zero. On the other hand, when the current-limiting coil 103 is turned off, the left term becomes almost zero, so the current-limiting coil 103 has almost no effect on the transmitter current. In other words, the current-limiting coil 103 has the potential to almost completely turn off the transmitter current or have almost no effect at all.

During regular power transmission operation (i.e., regular operation mode or non-current-limiting mode), electrical power is provided from the power source 106 to the power transmitting circuit 104. The power transmitting circuit 104 generates the alternating transmitter current from the provided electrical power (i.e., from the power source 106). The alternating transmitter current is applied to the transmitter coil 101. The alternating transmitter current flowing through the transmitter coil 101 generates the time-varying magnetic field. The receiver device 109 is placed adjacent the transmitter device 108 such that the receiver coil 102 is disposed within the magnetic field. The alternating current is induced in the receiver coil 102 due to the electromagnetic coupling with the magnetic field. The alternating current is converted into a usable output current by the power receiving circuit 105. The usable output current is provided to the load 107. Ideally, the current-limiting coil 103 has little to no affect on the above described power transmission operation, since the current-limiting coil 103 is open-circuited or turned off, or the impedance/reactance of the current-limiting coil 103 is adjusted to prevent significant electromagnetic interference with the magnetic field by the current-limiting coil 103. Thus, limiting the current or power in the wireless power transmission system 100 is generally achieved by controlling the impedance/reactance of the current-limiting coil 103.

If a user of the wireless power transmission system 100 has placed the receiver device 109 properly with respect to the transmitter device 108, then the receiver coil 102 is at the most advantageous location relative to the magnetic field for optimal or maximum power transfer or efficiency. For example, the transmitter device 108 may include a pad within which the transmitter coil 101 and the current-limiting coil 103 are disposed. The pad can be placed on the top surface of a table or desk, and the receiver device 109 can be placed flat on the top surface of and in the center of the pad, so that the receiver coil 102 is properly oriented and located where the magnetic field is at a maximum, thereby ensuring optimum power transfer or efficiency. However, the user might not be careful or diligent about placing the receiver device 109 in the optimum location or orientation. Also, the receiver device 109 may get inadvertently knocked out of the original user-placed location or orientation when other items are added to, removed from, or moved around on the desk surface. Additionally, other items might be placed on top of the pad of the transmitter device 108, and then the user might simply place the receiver device 109 on top of the other items. In any of these situations, the receiver coil 102 will not be in the optimum location or orientation with respect to the magnetic field or the transmitter coil 101, but will instead be at a greater distance from the transmitter coil 101 than the optimum distance and/or misaligned therewith, so the electromagnetic coupling between the two coils will be decreased or weakened. Consequently, the induced load in the transmitter coil 101, the power transferred therefrom, and/or the power transfer efficiency will be decreased. Furthermore, the conditions for overheating or potential damage to the transmitter device 108 and/or the receiver device 109 may occur. The operation of the current-limiting coil 103 in the current-limiting mode, however, prevents such conditions from occurring.

In some embodiments, the power transmitting circuit 104 is configured to monitor the input voltage and/or current level of the transmitter current applied to the transmitter coil 101. When the power transmitting circuit 104 detects that the input voltage and/or the transmitter current exceeds or rises above a safe or allowable maximum level for a voltage or current threshold (as can occur when the receiver coil 102 is within the magnetic field of the transmitter coil 101, but not at the optimum location or orientation), then the power transmitting circuit 104 is triggered to activate or turn on the current-limiting coil 103 or set the current-limiting coil 103 in the current-limiting mode. Additionally, when the power transmitting circuit 104 detects that the input voltage and/or the transmitter current is safely below (i.e., an acceptable amount below) the safe or allowable maximum level for the voltage or current threshold (as can occur when the receiver coil 102 is at or near the optimum location and orientation within the magnetic field of the transmitter coil 101), then the power transmitting circuit 104 is triggered to deactivate or turn off the current-limiting coil 103 or set the current-limiting coil 103 in the non-current-limiting mode. FIG. 2 illustrates alternative example embodiments in schematic diagrams 200 and 210 for setting the current-limiting coil 103 in the current-limiting mode and the non-current-limiting mode.

The embodiment of schematic diagram 200 has a variable resistor 204 (which may be considered to be part of the power transmitting circuit 104) that wire connects the end nodes 114 and 115 of the current-limiting coil 103 together. The power transmitting circuit 104 is wire connected via one or more control line 205 to the variable resistor 204. The power transmitting circuit 104 applies control signals on the control line 205 to the variable resistor 204 to set the impedance of the current-limiting coil 103 to set the current-limiting coil 103 in the current-limiting mode and to set back in the non-current-limiting mode. For the current-limiting mode, therefore, in response to detecting that the input voltage and/or the transmitter current exceeds or has risen above the safe or allowable maximum level for the voltage or current threshold, the power transmitting circuit 104 sets the impedance of the current-limiting coil 103 (i.e., an “on” condition) to induce an additional load in the transmitter coil 101 that will result in limiting the transmitter current to be at or below the safe or allowable maximum level for the voltage or current threshold (or an acceptable value offset from or above this level or threshold). On the other hand, for the non-current-limiting mode, in response to detecting that the input voltage and/or the transmitter current is safely below the safe or allowable maximum level for the voltage or current threshold, the power transmitting circuit 104 sets the impedance of the current-limiting coil 103 (i.e., an “off” condition) not to induce any additional load in, or to minimize the effect of the current-limiting coil 103 on, the transmitter coil 101, so that the transmitter current will not be limited any further than as may be due to the receiver coil 102 and/or ambient effects. Furthermore, in some embodiments, the variable resistor 204 may be set an any appropriate point for the impedance of the current-limiting coil 103 to be at any desired level between the “on” and “off” conditions, so that the transmitter current can be limited continuously or at several discrete levels between that of the current-limiting mode and the non-current-limiting mode, inclusive, for greater control and fine tuning of the transmitter current.

On the other hand, the embodiment of schematic diagram 210 has a switch 214 (e.g., a MOSFET device, a relay or any other appropriate switching device, which may be considered to be part of the power transmitting circuit 104) that wire connects the end nodes 114 and 115 of the current-limiting coil 103 together. The power transmitting circuit 104 is wire connected via one or more control line 215 to the switch 214. The power transmitting circuit 104 applies control signals on the control line 215 to the switch 214 to turn on (e.g., short circuit the end nodes 114 and 115 together, albeit with insignificant resistance of the switch 214) the current-limiting coil 103 to set the current-limiting coil 103 in the current-limiting mode and to turn off (e.g., open circuit the end nodes 114 and 115) the current-limiting coil 103 to set the current-limiting coil 103 in the non-current-limiting mode. For the current-limiting mode, therefore, in response to detecting that the input voltage and/or the transmitter current exceeds or has risen above the safe or allowable maximum level for the voltage or current threshold, the power transmitting circuit 104 turns on the current-limiting coil 103 to induce an additional load in the transmitter coil 101 that will result in limiting the transmitter current to be at or below the safe or allowable maximum level for the voltage or current threshold (or an acceptable value offset from or above this level or threshold). On the other hand, for the non-current-limiting mode, in response to detecting that the input voltage and/or the transmitter current is safely below the safe or allowable maximum level for the voltage or current threshold, the power transmitting circuit 104 turns off the current-limiting coil 103, so that it does not induce any additional load in, or has a minimal effect on, the transmitter coil 101, so that the transmitter current will not be limited any further than as may be due to the receiver coil 102 and/or ambient effects.

FIG. 3 provides a table 300 showing test results of a test implementation of the example wireless power transmission system 100, with test examples of the circuit components of FIG. 1 (i.e., a test transmitter circuit and a test receiver circuit having a test transmitter coil, a test receiver coil, a test current-limiting coil, a test power transmitting circuit, a test power receiving circuit, and a test load), and with a comparison to a conventional current-limiting technique. Four tests were conducted, as numbered tests 1-4 in a “test” column of the table 300. The circuitry and configuration of the test implementation of the wireless power transmission system 100 were generally the same for each test, except for the differences shown in the table 300. Additionally, these tests assume that the safe or allowable maximum level for the current threshold is about 1 A for the transmitter current. Other embodiments could use other threshold values, as appropriate to the specific application, or could use a voltage threshold.

A “description” column provides the current-limiting control conditions under which each test was conducted. For example, tests 1 and 2 were done with no current-limiting controls for the transmitter current in the test transmitter coil; test 3 was done by controlling or reducing the input voltage Vin to the test transmitter coil; and test 4 was done with the test current-limiting coil.

Additionally, a “gap” column provides the axial or vertical gap distance or offset in centimeters between the test transmitter coil and the test receiver coil for each test. (The relative horizontal offset or angular orientation between the test transmitter coil and the test receiver coil were generally the same for each test.) For example, test 1 was done with a gap of about 2.3 cm, which approximates an example situation in which a housing of the receiver device 109 is placed directly onto the top surface of the pad or housing within which the transmitter coil 101 is disposed. The 2.3 cm gap in this example situation accounts for the possible constraints that the pad or the housing for the transmitter coil 101 and the housing of the receiver device 109 each have some thickness that prevents the transmitter coil 101 and the receiver coil 102 from being placed immediately adjacent to each other. Otherwise, the test receiver coil was generally placed in a location relative to the test transmitter coil for optimum power transfer therebetween. On the other hand, tests 2-4 were done with a gap of about 4.3 cm, which approximates an example situation in which the receiver device 109 and the receiver coil 102 have been moved about 2 cm further away from the transmitter coil 101 in an axial or vertical direction, thereby necessitating some form of current limitation for the transmitter current.

Test 1 demonstrated an example regular power transmission operation (i.e., regular operation mode or non-current-limiting mode), wherein the test receiver coil is properly placed relative to the magnetic field or the test transmitter coil. For test 1, therefore, an input voltage Vin (“Vin” column) from the test transmitter circuit to the test transmitter coil was set at about 20 V, and the test load (“R-load” column) was provided at about 31.47 Ohms. With this input voltage Vin and load, a resulting transmitter current (input current “i-in” column) flowing in the test transmitter coil was about 0.75 A, a resulting output current (“i-out” column) from the test power receiving circuit to the test load was about 0.64 A, a resulting output voltage (“Vout” column) from the test power receiving circuit was about 20.04 V, a resulting output power provided to the load (“P-load” column) was about 12.8 W, and a resulting power transfer efficiency (“η*100%” column) was about 85.82%. Since the resulting transmitter current was below the safe or allowable maximum level for the current threshold, no current limiting was needed for test 1, since overheating or damage was unlikely.

Test 2 demonstrated an example situation that did not use current-limiting and, thus, showed why current-limiting was needed when the test receiver coil is placed further than is optimum from the test transmitter coil. For test 2, therefore, the input voltage Vin was again set at about 20 V, and the test load R-load was provided at about 31.58 Ohms (which was well within 1 percentage point of, and therefore comparable to, that of test 1). With this input voltage Vin and load, the resulting transmitter current i-in was about 1.59 A, the resulting output current i-out was about 0.90 A, the resulting output voltage Vout was about 28.53 V, the resulting output power P-load was about 25.8 W, and the resulting power transfer efficiency q*100% was about 82.22%. Since the resulting transmitter current was above the safe or allowable maximum level for the current threshold of about 1 A, current limiting should have been needed for test 2, so that the higher levels of the transmitter current, the output current, the output voltage, and the output power would not be a potential cause of overheating or damage.

Test 3 demonstrated an example conventional current-limiting technique that controls or reduces the input voltage Vin when the test receiver coil is placed further than is optimum from the test transmitter coil. For test 3, therefore, the input voltage Vin was reduced to about 12.4 V, and the test load R-load was provided at about 31.6 Ohms (which was well within 1 percentage point of, and therefore comparable to, that of test 1). With this input voltage Vin and load, the resulting transmitter current i-in was about 1 A, the resulting output current i-out was about 0.56 A, the resulting output voltage Vout was about 17.69 V, the resulting output power P-load was about 9.9 W, and the resulting power transfer efficiency q*100% was about 80.86%. Thus, the reduced input voltage Vin limited the resulting transmitter current to about the safe or allowable maximum level for the current threshold of about 1 A, so that the levels of the transmitter current, the output current, the output voltage, and the output power would not be a potential cause of overheating or damage. However, this conventional current-limiting technique produced the undesirable result of considerably lower output power delivered to the load than that of the example regular power transmission operation of test 1.

Test 4 demonstrated an example use of the current-limiting coil 103 for limiting the transmitter current when the test receiver coil is placed further than is optimum from the test transmitter coil. The test current-limiting coil was simply a closed single-loop wire placed in close proximity around the outside of the outer periphery of the test transmitter coil. For test 4, the input voltage Vin was maintained at about 20 V, as it was in test 1. Additionally, the test load R-load was provided at about 31.66 Ohms (which was well within 1 percentage point of, and therefore comparable to, that of test 1). With this input voltage Vin and load, the resulting transmitter current i-in was about 1 A, the resulting output current i-out was about 0.69 A, the resulting output voltage Vout was about 21.99 V, the resulting output power P-load was about 15.3 W, and the resulting power transfer efficiency q*100% was about 77.12%. Thus, the presence of the test current-limiting coil within the magnetic field around the test transmitter coil limited the resulting transmitter current to about the safe or allowable maximum level for the current threshold of about 1 A. Additionally, although the output current, the output voltage, and the output power were higher than those of test 1, these results were not significantly higher. Instead, the output current was less than 8% higher, the output voltage was less than 10% higher, and the output power was less than 20% higher. Additionally, these results were significantly lower than those of test 2, which carried a high risk of overheating or damage. Thus, the levels of the transmitter current, the output current, the output voltage, and the output power for test 4 are not likely to be a potential cause of overheating or damage. Furthermore, the output power was almost 55% higher than that of test 3 with a difference in efficiency of less than 4%, thereby demonstrating that the current-limiting coil technique of test 4 provided a better power transfer result than did the conventional current-limiting technique of test 3 with only a minor loss of efficiency. The efficiency loss was generally due to the power dissipated on the active resistance of the test current-limiting coil, so the loss can potentially be decreased with a better design than that used for the test current-limiting coil.

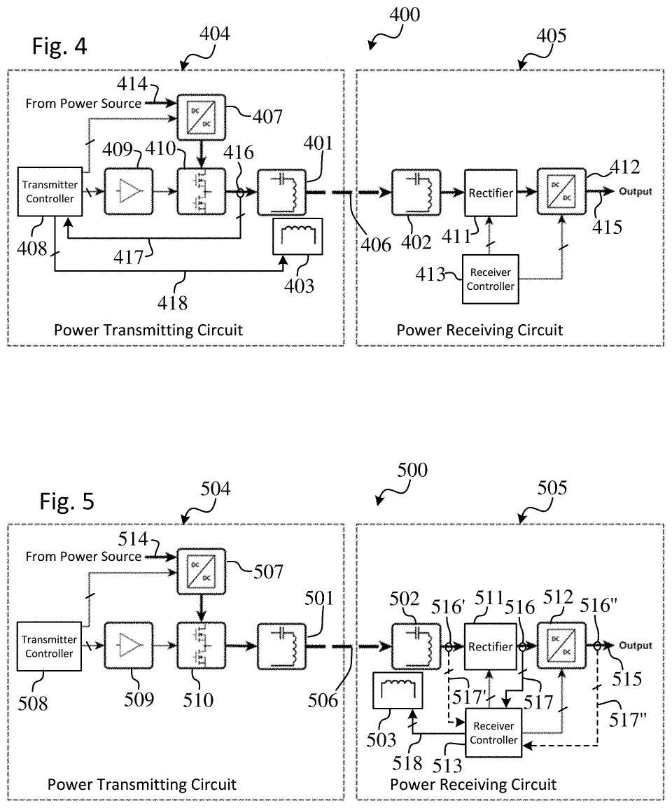

An example implementation of the wireless power transmission system 100 (FIG. 1) is provided in an improved wireless power transmission system 400 shown in FIG. 4, in accordance with some embodiments. The wireless power transmission system 400 generally includes a power transmitting circuit 404 and a power receiving circuit 405 for wirelessly transmitting electromagnetic power (at 406) therebetween. The power transmitting circuit 404 generally includes a resonant transmitter coil 401, a current-limiting coil 403, a voltage pre-regulator 407, a transmitter controller 408, a driver circuit 409, and at least one power block 410, among other components not shown for simplicity. The power receiving circuit 405 generally includes a resonant receiver coil 402, a rectifier 411, a voltage post regulator 412, and a receiver controller 413, among other components not shown for simplicity. The wireless power transmission system 400 generates the transmitted electromagnetic power at 406 from an input voltage (and current) received at 414 from a power source (e.g., 106) and generates an output voltage (and current) at 415 from the transmitted electromagnetic power.

The transmitter coil 401, the receiver coil 402 and the current-limiting coil 403 may be similar to the transmitter coil 101, the receiver coil 102 and the current-limiting coil 103, respectively, with inductive and capacitive elements. The wireless power transmission system 400 is, thus, an example of an embodiment in which the current-limiting coil 403 is a separate coil from the transmitter coil 401 and the receiver coil 402, and the current-limiting coil 403 is part of or wire connected to the power transmitting circuit 404.

The transmitter controller 408 is wire connected to the current-limiting coil 403, the driver circuit 409, and the voltage pre-regulator 407 to provide control or operating signals thereto. The transmitter controller 408 is also wire connected to a voltage or current sensor at 416 between the power block 410 and the transmitter coil 401. The transmitter controller 408 is, thus, any appropriate circuitry that can determine the control or operating signals in response to at least one feedback signal received from the sensor at 416 (e.g., via a feedback line 417) related to the voltage and/or current level of the transmitter current provided to the transmitter coil 401. In some embodiments, the control or operating signals for the current-limiting coil 403, for example, may be provided via a control line 418 (such as the control line 205 or 215) to a variable resistor or switch (e.g., 204 or 214) for setting the current-limiting coil 403 in the current-limiting mode and the non-current-limiting mode.

The driver circuit 409 is wire connected to the transmitter controller 408 and the power block 410. The driver circuit 409 is generally any appropriate circuitry that can provide switch drive signals, such as gate voltages for MOSFET devices, to control the power block 410 in response to the control or operating signals received from the transmitter controller 408.

The voltage pre-regulator 407 is wire connected to the power source 106 at 414, the transmitter controller 408, and the power block 410. The voltage pre-regulator 407 is generally any appropriate circuitry that can convert the input voltage received at 414 to a desired voltage and current for use by the power block 410 in response to the control or operating signals received from the transmitter controller 408. In some embodiments, the voltage pre-regulator 407 may not be needed if the input voltage at 414 from the power source 106 is already at the desired voltage and current level.

The power block 410 is wire connected to the driver circuit 409, the voltage pre-regulator 407, and the transmitter coil 401. The power block 410 is generally an appropriate circuitry (e.g., a MOSFET half-bridge converter) that can convert the voltage provided from the voltage pre-regulator 407 to the proper voltage and current level of the transmitter current applied to the transmitter coil 401 in response to the switch drive signals received from the driver circuit 409.

The receiver controller 413 is wire connected to the rectifier 411 and the voltage post regulator 412 to provide control or operating signals thereto. The receiver controller 413 is, thus, any appropriate circuitry that can determine the control or operating signals in response to any appropriate one or more feedback signal received from an appropriate node between the receiver coil 402 and the output at 415.

The rectifier 411 is wire connected to the receiver coil 402, the voltage post regulator 412, and the receiver controller 413. The rectifier 411 is generally any appropriate circuitry for rectifying the alternating current induced in the receiver coil 402 into a DC or rectified current, according to the control or operating signals received from the receiver controller 413. For example, the rectifier 411 may be a passive diode rectification bridge or an active switching rectification bridge. If it is a passive diode rectification bridge, the rectifier 411 may not need the control or operating signals.

The voltage post regulator 412 is wire connected to the rectifier 411, the receiver controller 413, and the load 107 (e.g., via the output at 415). The voltage post regulator 412 is generally any appropriate circuitry, such as a DC-DC voltage regulator, for regulating the rectified current received from the rectifier 411 to a desired output voltage and current for the load 107, according to the control or operating signals received from the receiver controller 413.

During operation of the wireless power transmission system 400, the transmitter controller 408 determines (e.g., in response to feedback signals, such as that received via the feedback line 417 from the sensor at 416) which operating mode (e.g., the regular operation or non-current-limiting mode, the current-limiting mode, and the no-load situation mode) the wireless power transmission system 400 should be in. Accordingly, the transmitter controller 408 sets the operating mode via the control or operating signals provided to the current-limiting coil 403 (e.g., via the control line 418), the driver circuit 409, and the voltage pre-regulator 407. For example, if the transmitter controller 408 detects a non-current-limiting mode, as indicated by the voltage and/or current level of the transmitter current being within or below (e.g., an acceptable amount below) the safe or allowable maximum level for the voltage or current threshold of the transmitter current, then the transmitter controller 408 turns off the current-limiting coil 403 via the control line 418. On the other hand, if the transmitter controller 408 detects a current-limiting mode, as indicated by the voltage and/or current level of the transmitter current being above the safe or allowable maximum level for the voltage or current threshold of the transmitter current, then the transmitter controller 408 turns on the current-limiting coil 403 via the control line 418.

During regular power transmission operation (i.e., the regular operation mode or non-current-limiting mode), electrical power is provided from the power source 106 through the voltage pre-regulator 407 to the power block 410. The power block 410 generates the alternating transmitter current from the provided electrical power under control of the driver circuit 409, in accordance with the control by the transmitter controller 408. The alternating transmitter current is applied to the transmitter coil 401. The transmitter controller 408 monitors the voltage and/or current level of the alternating transmitter current (e.g., via the feedback received via the feedback line 417 from the sensor at 416) in order to maintain the regular power operation (i.e., with the current-limiting coil 403 maintained as turned off by the control or operating signals provided via the control line 418) or to switch to the current-limiting mode (i.e., by turning on the current-limiting coil 403 via the control or operating signals provided via the control line 418).

The alternating transmitter current flowing through the transmitter coil 401 generates the time-varying magnetic field. The receiver device 109 is placed adjacent the transmitter device 108 such that the receiver coil 402 is disposed within the magnetic field. The alternating current is induced in the receiver coil 402 due to the electromagnetic coupling with the magnetic field. The alternating current is rectified by the rectifier 411 into the rectified current, which is converted or regulated into a usable output voltage and current by the voltage post regulator 412, in accordance with the controls from the receiver controller 413. The usable output voltage and current is provided at the output at 415 to the load 107.

During the non-current-limiting mode, when the transmitter controller 408 detects a need to enter the current-limiting mode (i.e., as indicated by the voltage and/or current level of the transmitter current rising above the safe or allowable maximum level for the voltage or current threshold of the transmitter current), the transmitter controller 408 turns on the current-limiting coil 403 via the control or operating signals provided via the control line 418. The wireless power transmission system 400 (or the power transmitting circuit 404 or the current-limiting coil 403), thus, enters the current-limiting mode. During the current-limiting mode, the current-limiting coil 403 induces an additional load in the transmitter coil 401 that results in limiting the transmitter current to be about at or below the safe or allowable maximum level for the voltage or current threshold (or an acceptable value offset from or above this level or threshold). The transmitter coil 401 continues to generate the magnetic field, albeit with the limited transmitter current.

Additionally, the transmitter controller 408 continues to monitor the voltage and/or current level of the alternating transmitter current (e.g., via the feedback received via the feedback line 417 from the sensor at 416) in order to maintain the current-limiting mode or to switch to the regular power operation. The transmitter controller 408 maintains the current-limiting mode by maintaining the current-limiting coil 403 turned on by the control or operating signals provided via the control line 418 in response to the transmitter current being about at or above the safe or allowable maximum level for the voltage or current threshold (e.g., within an acceptable amount for an appropriate hysteresis). Additionally, during the current-limiting mode, when the transmitter controller 408 detects that the transmitter current has fallen safely below the safe or allowable maximum level for the voltage or current threshold, the transmitter controller 408 switches to the regular power operation by turning off the current-limiting coil 403 via the control or operating signals provided via the control line 418.

FIG. 5 shows an alternative example of an improved wireless power transmission system 500, in accordance with some embodiments. The wireless power transmission system 500 generally includes a power transmitting circuit 504 (of a transmitter device) and a power receiving circuit 505 (of a receiver device) for wirelessly transmitting electromagnetic power (at 506) therebetween. The power transmitting circuit 504 generally includes a resonant transmitter coil 501, a voltage pre-regulator 507, a transmitter controller 508, a driver circuit 509, and at least one power block 510, among other components not shown for simplicity. The power receiving circuit 505 generally includes a resonant receiver coil 502, a current-limiting coil 503, a rectifier 511, a voltage post regulator 512, and a receiver controller 513, among other components not shown for simplicity. The wireless power transmission system 500 generates the transmitted electromagnetic power at 506 from an input voltage (and current) received at 514 from a power source (e.g., similar to 106) and generates an output voltage (and current) at 515 from the transmitted electromagnetic power.

The transmitter coil 501, the receiver coil 502 and the current-limiting coil 503 may be similar to the transmitter coil 101, the receiver coil 102 and the current-limiting coil 103, respectively, with inductive and capacitive elements. The wireless power transmission system 500 is, however, an example of an embodiment in which the current-limiting coil 503 is a separate coil from the transmitter coil 501 and the receiver coil 502, and the current-limiting coil 503 is part of or wire connected to the power receiving circuit 505.

The transmitter controller 508 is wire connected to the driver circuit 509 and the voltage pre-regulator 507 to provide control or operating signals thereto. The transmitter controller 508 is, thus, any appropriate circuitry that can determine the control or operating signals in response to any appropriate one or more feedback signal (not shown) received from an appropriate node between the voltage pre-regulator 507 and the transmitter coil 501.

The driver circuit 509 is wire connected to the transmitter controller 508 and the power block 510. The driver circuit 509 is generally any appropriate circuitry that can provide switch drive signals, such as gate voltages for MOSFET devices, to control the power block 510 in response to the control or operating signals received from the transmitter controller 508.

The voltage pre-regulator 507 is wire connected to the power source (e.g., similar to 106) at 514, the transmitter controller 508, and the power block 510. The voltage pre-regulator 507 is generally any appropriate circuitry that can convert the input voltage received at 514 to a desired voltage and current for use by the power block 510 in response to the control or operating signals received from the transmitter controller 508. In some embodiments, the voltage pre-regulator 507 may not be needed if the input voltage at 514 is already at the desired voltage and current level.

The power block 510 is wire connected to the driver circuit 509, the voltage pre-regulator 507, and the transmitter coil 501. The power block 510 is generally an appropriate circuitry (e.g., a MOSFET half-bridge converter) that can convert the voltage provided from the voltage pre-regulator 507 to the proper voltage and current level of the transmitter current applied to the transmitter coil 501 in response to the switch drive signals received from the driver circuit 509.

The receiver controller 513 is wire connected to the current-limiting coil 503, the rectifier 511, and the voltage post regulator 512 to provide control or operating signals thereto. In some embodiments, the receiver controller 513 is also wire connected to a voltage or current sensor at 516 between the rectifier 511 and the voltage post regulator 512. (Alternatively, the receiver controller 513 is also wire connected to a voltage or current sensor at 516′ between the receiver coil 502 and the rectifier 511 or wire connected to a voltage or current sensor at 516″ at the output of the voltage post regulator 512.) The receiver controller 513 is, thus, any appropriate circuitry that can determine the control or operating signals in response to at least one feedback signal received from the sensor at 516, 516′ or 516″ (e.g., via a feedback line 517, 517′ or 517″) related to the voltage and/or current level of a receiver current. The receiver current may, thus, be the rectified current produced by the rectifier (at 516), the alternating current induced in the receiver coil (at 516′), or the output current applied to the load (at 516″). In some embodiments, the control or operating signals for the current-limiting coil 503, for example, may be provided via a control line 518 (e.g., similar to the control line 205 or 215) to a variable resistor or switch (e.g., similar to 204 or 214) for setting the current-limiting coil 503 in the current-limiting mode and the non-current-limiting mode.

The rectifier 511 is wire connected to the receiver coil 502, the voltage post regulator 512, and the receiver controller 513. The rectifier 511 is generally any appropriate circuitry for rectifying the alternating current induced in the receiver coil 502 into a DC or rectified current, according to the control or operating signals received from the receiver controller 513. For example, the rectifier 511 may be a passive diode rectification bridge or an active switching rectification bridge. If it is a passive diode rectification bridge, the rectifier 511 may not need the control or operating signals.

The voltage post regulator 512 is wire connected to the rectifier 511, the receiver controller 513, and the load 107 (e.g., via the output at 515). The voltage post regulator 512 is generally any appropriate circuitry, such as a DC-DC voltage regulator, for regulating the rectified current received from the rectifier 511 to a desired output voltage and current for the load 107, according to the control or operating signals received from the receiver controller 513.

During operation of the wireless power transmission system 500, the receiver controller 513 determines (e.g., in response to feedback signals, such as that received via the feedback line 517, 517′ or 517″ from the sensor at 516, 516′ or 516″) which operating mode (e.g., the regular operation or non-current-limiting mode, and the current-limiting mode) the wireless power transmission system 500 should be in. (The transmitter controller 508 handles the no-load situation mode.) Accordingly, the receiver controller 513 sets the operating mode via the control or operating signals provided to the current-limiting coil 503 (e.g., via the control line 518). For example, if the receiver controller 513 detects a non-current-limiting mode, as indicated by the voltage and/or current level of the receiver current being within or below a safe or allowable maximum level for the voltage or current threshold of the receiver current, then the receiver controller 513 turns off the current-limiting coil 503 via the control line 518. On the other hand, if the receiver controller 513 detects a current-limiting mode, as indicated by the voltage and/or current level of the receiver current being above the safe or allowable maximum level for the voltage or current threshold of the receiver current, then the receiver controller 513 turns on the current-limiting coil 503 via the control line 518.

During regular power transmission operation (i.e., the regular operation mode or non-current-limiting mode), electrical power is provided from the power source (e.g., similar to 106) through the voltage pre-regulator 507 to the power block 510. The power block 510 generates the alternating transmitter current from the provided electrical power under control of the driver circuit 509, in accordance with the control by the transmitter controller 508. The alternating transmitter current is applied to the transmitter coil 501.

The alternating transmitter current flowing through the transmitter coil 501 generates the time-varying magnetic field. The receiver device is placed adjacent the transmitter device such that the receiver coil 502 is disposed within the magnetic field. (Although the current-limiting coil 503 is within the power receiving circuit 505 of the receiver device, the current-limiting coil 503 is disposed within the receiver device at a location wherein it will be near the transmitter coil 501 and within the magnetic field when the receiver device is placed on the transmitter device or a pad thereof containing the transmitter coil 501.) The alternating current is induced in the receiver coil 502 due to the electromagnetic coupling with the magnetic field. The alternating current is rectified by the rectifier 511 into the rectified current, which is converted or regulated into a usable output voltage and current by the voltage post regulator 512, in accordance with the controls from the receiver controller 513. The usable output voltage and current is provided at the output at 515 to the load 107.

The receiver controller 513 monitors the voltage and/or current level of the receiver current (e.g., via the feedback received via the feedback line 517, 517′ or 517″ from the sensor at 516, 516′ or 516″) in order to maintain the regular power operation (i.e., with the current-limiting coil 503 maintained as turned off by the control or operating signals provided via the control line 518) or to switch to the current-limiting mode (i.e., by turning on the current-limiting coil 503 via the control or operating signals provided via the control line 518).

During the non-current-limiting mode, when the receiver controller 513 detects a need to enter the current-limiting mode (i.e., as indicated by the voltage and/or current level of the receiver current rising above the safe or allowable maximum level for the voltage or current threshold of the receiver current), the receiver controller 513 turns on the current-limiting coil 503 via the control or operating signals provided via the control line 518. The wireless power transmission system 500 (or the power receiving circuit 505 or the current-limiting coil 503), thus, enters the current-limiting mode. During the current-limiting mode, the current-limiting coil 503 induces an additional load in the transmitter coil 501 that results in limiting the transmitter current to be about at or below the safe or allowable maximum level for the voltage or current threshold (or an acceptable value offset from or above this level or threshold) of the transmitter current. The transmitter coil 501 continues to generate the magnetic field, albeit with the limited transmitter current, which results in the receiver current being about at or below the safe or allowable maximum level for the voltage or current threshold of the receiver current.

Additionally, the receiver controller 513 continues to monitor the voltage and/or current level of the receiver current (e.g., via the feedback received via the feedback line 517, 517′ or 517″ from the sensor at 516, 516′ or 516″) in order to maintain the current-limiting mode or to switch to the regular power operation. The receiver controller 513 maintains the current-limiting mode by maintaining the current-limiting coil 503 turned on by the control or operating signals provided via the control line 518 in response to the receiver current being about at or above the safe or allowable maximum level for the voltage or current threshold for the receiver current. Additionally, during the current-limiting mode, when the receiver controller 513 detects that the receiver current has fallen safely below (e.g., an acceptable amount below) the safe or allowable maximum level for the voltage or current threshold, the receiver controller 513 switches to the regular power operation by turning off the current-limiting coil 503 via the control or operating signals provided via the control line 518.

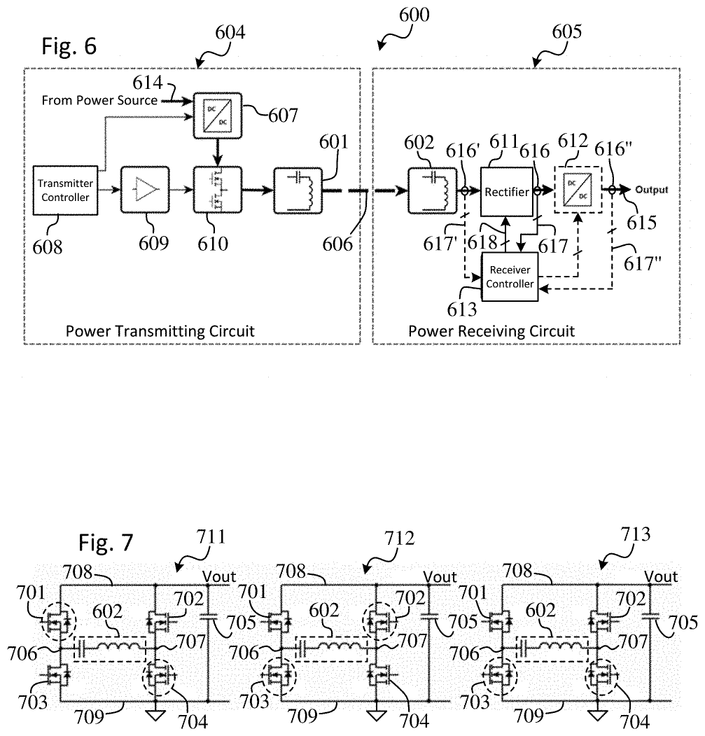

FIG. 6 shows an alternative example of an improved wireless power transmission system 600, in accordance with some embodiments. The wireless power transmission system 600 generally includes a power transmitting circuit 604 (of a transmitter device) and a power receiving circuit 605 (of a receiver device) for wirelessly transmitting electromagnetic power (at 606) therebetween. The power transmitting circuit 604 generally includes a resonant transmitter coil 601, a voltage pre-regulator 607, a transmitter controller 608, a driver circuit 609, and at least one power block 610, among other components not shown for simplicity. The power receiving circuit 605 generally includes a resonant receiver coil 602, a rectifier 611, a voltage post regulator 612, and a receiver controller 613, among other components not shown for simplicity. The wireless power transmission system 600 generates the transmitted electromagnetic power at 606 from an input voltage (and current) received at 614 from a power source (e.g., similar to 106) and generates an output voltage (and current) at 615 from the transmitted electromagnetic power.

The transmitter coil 601 and the receiver coil 602 may be similar to the transmitter coil 101 and the receiver coil 102, respectively, with inductive and capacitive elements. The wireless power transmission system 600 is, however, an example of an embodiment in which the receiver coil 602 is used as the current-limiting coil. Therefore, the receiver coil 602 is configured to operate in a current-limiting mode and to operate in a power receiving mode (i.e., the regular operation mode or non-current-limiting mode).

The transmitter controller 608 is wire connected to the driver circuit 609 and the voltage pre-regulator 607 to provide control or operating signals thereto. The transmitter controller 608 is, thus, any appropriate circuitry that can determine the control or operating signals in response to any appropriate one or more feedback signal received from an appropriate node between the voltage pre-regulator 607 and the transmitter coil 601.

The driver circuit 609 is wire connected to the transmitter controller 608 and the power block 610. The driver circuit 609 is generally any appropriate circuitry that can provide switch drive signals, such as gate voltages for MOSFET devices, to control the power block 610 in response to the control or operating signals received from the transmitter controller 608.

The voltage pre-regulator 607 is wire connected to the power source (e.g., similar to 106) at 614, the transmitter controller 608, and the power block 610. The voltage pre-regulator 607 is generally any appropriate circuitry that can convert the input voltage received at 614 to a desired voltage and current for use by the power block 610 in response to the control or operating signals received from the transmitter controller 608. In some embodiments, the voltage pre-regulator 607 may not be needed if the input voltage at 614 is already at the desired voltage and current level.

The power block 610 is wire connected to the driver circuit 609, the voltage pre-regulator 607, and the transmitter coil 601. The power block 610 is generally an appropriate circuitry (e.g., a MOSFET half-bridge converter) that can convert the voltage provided from the voltage pre-regulator 607 to the proper voltage and current level of the transmitter current applied to the transmitter coil 601 in response to the switch drive signals received from the driver circuit 609.

The receiver controller 613 is wire connected to the rectifier 611 and the voltage post regulator 612 to provide control or operating signals thereto. In some embodiments, the receiver controller 613 is also wire connected to a voltage or current sensor at 616 between the rectifier 611 and the voltage post regulator 612. (Alternatively, the receiver controller 613 is also wire connected to a voltage or current sensor at 616′ between the receiver coil 602 and the rectifier 611 or wire connected to a voltage or current sensor at 616″ at the output of the voltage post regulator 612.) The receiver controller 613 is, thus, any appropriate circuitry that can determine the control or operating signals in response to at least one feedback signal received from the sensor at 616, 616′ or 616″ (e.g., via a feedback line 617, 617′ or 617″) related to the voltage and/or current level of a receiver current. The receiver current may, thus, be the rectified current produced by the rectifier (at 616), the alternating current induced in the receiver coil (at 616′), or the output current applied to the load (at 616″). In some embodiments, one or more control or operating signals for the rectifier 611, for example, may be provided via a control line 618 to the rectifier 611 for setting the receiver coil 602 (as the current-limiting coil) in the current-limiting mode and the non-current-limiting mode.

The rectifier 611 is wire connected to the receiver coil 602, the voltage post regulator 612, and the receiver controller 613. The rectifier 611 is generally any appropriate circuitry for rectifying the alternating current induced in the receiver coil 602 into a DC or rectified current, according to the one or more control or operating signals received from the receiver controller 613. Additionally, since the receiver coil 602 also serves as the current-limiting coil, the receiver coil 602 is configured to operate in the current-limiting mode and to operate in the power receiving mode, in accordance with the one or more control or operating signals from the receiver controller for controlling the rectifier 611.

In some embodiments, the rectifier 611, as shown in FIG. 7, may be an active switching rectification bridge, or active rectifier, having switches 701-704 (e.g., MOSFET devices) and an output capacitor 705. The first switch 701 is wire connected between a first end node 706 of the receiver coil 602 and an output node 708 for a DC output voltage Vout or rectified current of the active rectifier 611. The second switch 702 is wire connected between a second end node 707 of the receiver coil 602 and the output node 708. The third switch 703 is wire connected between the first end node 706 of the receiver coil 602 and a ground node 709. The fourth switch 704 is wire connected between the second end node 707 of the receiver coil 602 and the ground node 709.

FIG. 7 shows three operating configurations 711, 712 and 713 for the rectifier 611 and the receiver coil 602 to operate in the power receiving mode and the current-limiting mode. In the power receiving mode, the switches 701-704 of the rectifier 611 alternate (e.g., at the frequency of the alternating current) between the configurations 711 and 712 to actively rectify the alternating current induced in or generated by the receiver coil 602 to generate the DC output voltage Vout. In other words, activation of the first and fourth switches 701 and 704 (configuration 711) alternates with activation of the second and third switches 702 and 703 (configuration 712) to actively rectify the alternating current. The output voltage Vout is filtered or smoothed out by the output capacitor 705. On the other hand, in the current-limiting mode (configuration 713), the first and second switches 701 and 702 are open and the third and fourth switches 703 and 704 are closed to wire connect the first and second end nodes 706 and 707 of the receiver coil 602 to the ground node 709. In other words, the switches 703 and 704 of the rectifier 611 wire connect the first and second end nodes 706 and 707 of the receiver coil 602 together, i.e., in effect creating a short circuit of the receiver coil 602 to ground and converting the receiver coil 602 into a current-limiting coil.

The voltage post regulator 612 is wire connected to the rectifier 611, the receiver controller 613, and the load 107 (e.g., via the output at 615). The voltage post regulator 612 is generally any appropriate circuitry, such as a DC-DC voltage regulator, for regulating the rectified current received from the rectifier 611 to a desired output voltage and current for the load 107, according to the control or operating signals received from the receiver controller 613.

During operation of the wireless power transmission system 600, the receiver controller 613 determines (e.g., in response to feedback signals, such as that received via the feedback line 617, 617′ or 617″ from the sensor at 616, 616′ or 616″) which operating mode (e.g., the regular operation or non-current-limiting mode, and the current-limiting mode) the wireless power transmission system 600 should be in. (The transmitter controller 608 handles the no-load situation mode.) Accordingly, the receiver controller 613 sets the operating mode via the control or operating signals provided to the rectifier 611 (e.g., via the control line 618). For example, if the receiver controller 613 detects a non-current-limiting mode, as indicated by the voltage and/or current level of the receiver current being within or below a safe or allowable maximum level for the voltage or current threshold of the receiver current, then the receiver controller 613 operates the switches 701-704 of the rectifier 611 via the control line 618, as described above, to actively rectify the alternating current induced in or generated by the receiver coil 602 to generate the DC output voltage Vout for the rectified current. On the other hand, if the receiver controller 613 detects a current-limiting mode, as indicated by the voltage and/or current level of the receiver current being above the safe or allowable maximum level for the voltage or current threshold of the receiver current, then the receiver controller 613 operates the switches 701-704 of the rectifier 611 via the control line 618, as described above, to wire connect the first and second end nodes 706 and 707 of the receiver coil 602 to the ground node 709.

During regular power transmission operation (i.e., the regular operation mode or non-current-limiting mode), electrical power is provided from the power source (e.g., similar to 106) through the voltage pre-regulator 607 to the power block 610. The power block 610 generates the alternating transmitter current from the provided electrical power under control of the driver circuit 609, in accordance with the control by the transmitter controller 608. The alternating transmitter current is applied to the transmitter coil 601. The alternating transmitter current flowing through the transmitter coil 601 generates the time-varying magnetic field. The receiver device is placed adjacent the transmitter device such that the receiver coil 602 is disposed within the magnetic field. The alternating current is induced in the receiver coil 602 due to the electromagnetic coupling with the magnetic field. The alternating current is rectified by the rectifier 611 into the rectified current, which is converted or regulated into a usable output voltage and current by the voltage post regulator 612, in accordance with the controls from the receiver controller 613. The usable output voltage and current is provided at the output at 615 to the load 107.

The receiver controller 613 monitors the voltage and/or current level of the receiver current (e.g., via the feedback received via the feedback line 617, 617′ or 617″ from the sensor at 616, 616′ or 616″) in order to maintain the power receiving mode during regular power operation or to switch between the power receiving mode and the current-limiting mode. For example, when the receiver controller 613 detects a need to enter the current-limiting mode (i.e., as indicated by the voltage and/or current level of the receiver current rising above the safe or allowable maximum level for the voltage or current threshold of the receiver current), the receiver controller 613 operates the switches 701-704 to wire connect the first and second end nodes 706 and 707 of the receiver coil 602 to the ground node 709 by the control or operating signals provided via the control line 618. The wireless power transmission system 600 (or the power receiving circuit 605 or the receiver coil 602 or the rectifier 611), thus, enters the current-limiting mode. During the current-limiting mode, the receiver coil 602 induces an additional load in the transmitter coil 601 that results in limiting the transmitter current to be about at or below the safe or allowable maximum level for the voltage or current threshold (or an acceptable value offset from or above this level or threshold) of the transmitter current. The transmitter coil 601 continues to generate the magnetic field, albeit with the limited transmitter current. However, since the receiver coil 602 is in effect short circuited during this time, the receiver current depends on stored energy in the output capacitor 705, which decays such that the receiver current decreases. Then when the receiver controller 613 detects that the receiver current is about at or below the safe or allowable maximum level for the voltage or current threshold of the receiver current, the receiver controller 613 returns the wireless power transmission system 600 to the power receiving mode. This switching between power receiving mode and current-limiting mode continues, as once again the voltage or current level rises above the safe or allowable maximum level for the voltage or current threshold of the receiver current. In other words, the receiver controller 613 can operate the rectifier 611 and thus the receiver coil 602 to frequently and rapidly switch the wireless power transmission system 600 between the power receiving mode and the current-limiting mode. The net effect provides for regulating the voltage and current level of the receiver current. Therefore, this embodiment enables dynamic control of the receiver coil 602 to tune a desired variable in the wireless power transmission system 600, i.e., regulating the output voltage Vout in this example. Furthermore, in some embodiments, the voltage post regulator 612 is not needed, because the operation of the rectifier 611 and the receiver coil 602 in switching back and forth between the power receiving mode and the current-limiting mode can provide sufficient regulation of the output voltage and current at the output at 615 for the load 107.

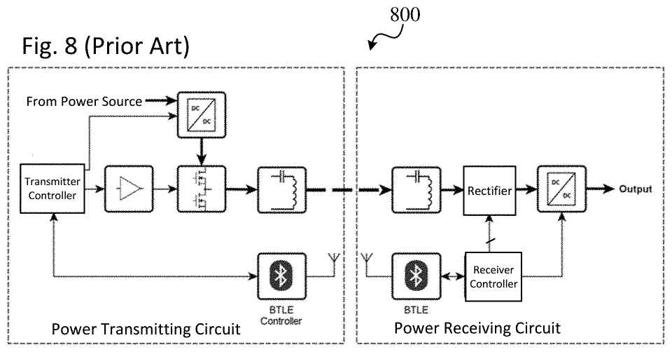

The wireless power transmission systems 400, 500 and 600 are contrasted with an example conventional wireless power transmission system 800 shown in FIG. 8. The conventional system 800 generally requires some form of additional communication between the power transmitting circuit and the power receiving circuit. For example, a Bluetooth Low Energy (BTLE) controller and antenna may be required in both the power transmitting circuit and the power receiving circuit in order to manage current-limiting functions between the transmitter and receiver devices. The wireless power transmission systems 400, 500 and 600, on the other hand, do not require this additional circuitry. Thus, the wireless power transmission systems 400, 500 and 600 potentially enable simpler, smaller and cheaper circuitries. Additionally, the use of the current-limiting coil can result in a faster and/or more efficient response for current-limiting functions than can the conventional BTLE-based systems.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A wireless power transmission system comprising:
a transmitter coil in a power transmitting circuit, the transmitter coil generating a magnetic field for transmitting electromagnetic power by a transmitter current flowing within the transmitter coil; and
a receiver coil in a power receiving circuit and that can be disposed within the magnetic field, the receiver coil being configured to operate in a power receiving mode and to operate in a current-limiting mode, the receiver coil receiving at least a portion of the electromagnetic power from the magnetic field, the receiver coil generating a receiver current and a first opposing magnetic field from the magnetic field in the power receiving mode, the receiver coil generating a second opposing magnetic field from the magnetic field without generating the receiver current in the current-limiting mode, the second opposing magnetic field having a greater magnitude than that of the first opposing magnetic field, and the second opposing magnetic field limiting the transmitter current.

2. The wireless power transmission system of claim 1, further comprising:
an active rectifier that is wire connected to the receiver coil;
wherein:
in the power receiving mode, the active rectifier actively rectifies the receiver current generated by the receiver coil; and
in the current-limiting mode, the active rectifier wire connects first and second end nodes of the receiver coil.

3. The wireless power transmission system of claim 2, wherein:
the active rectifier comprises a first switch wire connected between the first end node of the receiver coil and an output node of the active rectifier, a second switch wire connected between the second end node of the receiver coil and the output node of the active rectifier, a third switch wire connected between the first end node of the receiver coil and a ground, and a fourth switch wire connected between the second end node of the receiver coil and the ground;
in the power receiving mode, activation of the first and fourth switches alternates with activation of the second and third switches to actively rectify the receiver current generated by the receiver coil; and
in the current-limiting mode, the first and second switches are open and the third and fourth switches are closed to wire connect the first and second end nodes of the receiver coil to the ground.

4. The wireless power transmission system of claim 2, further comprising:
a receiver controller in the power receiving circuit;
wherein:
the active rectifier is wire connected to the receiver controller to receive control signals that control operation of the active rectifier;
the receiver controller produces the control signals to cause the active rectifier to actively rectify the receiver current generated by the receiver coil in the power receiving mode; and
the receiver controller produces the control signals to cause the active rectifier to wire connect the first and second end nodes of the receiver coil in the current-limiting mode.

5. The wireless power transmission system of claim 4, wherein:
the control signals are based on a voltage or current level of the receiver current produced by the receiver coil.

6. A method comprising:
generating a transmitter current in a power transmitting circuit;
applying the transmitter current to a transmitter coil in the power transmitting circuit;
the transmitter coil generating a magnetic field for wirelessly transmitting electromagnetic power due to the transmitter current;
during a non-current-limiting mode, the transmitter coil receiving a first opposing magnetic field that is generated from the magnetic field by a receiver coil that is disposed within the magnetic field;
during a current-limiting mode, the transmitter coil receiving a second opposing magnetic field that is generated from the magnetic field by the receiver coil, the second opposing magnetic field having a greater magnitude than the first opposing magnetic field in the current-limiting mode; and
during the current-limiting mode, limiting the transmitter current in the power transmitting circuit below a safe operating current threshold due to the second opposing magnetic field.

7. The method of claim 6, further comprising:
during the non-current-limiting mode, the receiver coil generating a receiver current from the magnetic field, and the non-current-limiting mode being a power receiving mode;
when a voltage or current level of the receiver current rises above a voltage or current threshold, setting the receiver coil to the current-limiting mode and generating the second opposing magnetic field by the receiver coil; and
when the voltage or current level of the receiver current falls below the voltage or current threshold, setting the receiver coil to the power receiving mode and repeating the generating of the receiver current.

8. The method of claim 7, further comprising:
setting the receiver coil to the current-limiting mode by controlling switches of an active rectifier to wire connect end nodes of the receiver coil; and
setting the receiver coil to the power receiving mode by controlling the switches of the active rectifier to actively rectify the receiver current generated by the receiver coil.
